(19) United States
(12) Patent Application Publication
(10) Pub. No.: US 2019/0280768 A1
(43) Pub. Date: Sep. 12, 2019

(54) METHOD AND DEVICE FOR DETERMINING STATE OF OPTICAL NETWORK TERMINAL LINE

(71) Applicant: ELECTRONICS AND TELECOMMUNICATIONS RESEARCH INSTITUTE, Daejeon (KR)

(72) Inventors: Byung-Hee SON, Gwangju (KR); Geun Yong KIM, Gwangju (KR); Ryangsoo KIM, Gwangju (KR); Jaein KIM, Gwangju (KR); Hee Do KIM, Seoul (KR); Moon Kyun OH, Daejeon (KR); Hark YOO, Gwangju (KR); Gi-Ha YOON, Gwangju (KR)

(73) Assignee: ELECTRONICS AND TELECOMMUNICATIONS RESEARCH INSTITUTE, Daejeon (KR)

(21) Appl. No.: 16/351,100

(22) Filed: Mar. 12, 2019

(30) Foreign Application Priority Data
Mar. 12, 2018 (KR) 10-2018-0028887

(51) Int. Cl. H04B 10/079; H04B 10/572; H04Q 11/00

(52) U.S. Cl. CPC H04B 10/0799; H04Q 11/0067; H04B 10/572; H04B 10/0795

(57) ABSTRACT

In the present invention, by providing a device for determining a state of an optical network terminal line including: an optical signal transfer interface configured to transfer a downlink signal transmitted from an optical line terminal to an optical network terminal line and to transfer an uplink signal transmitted from an optical network terminal connected to the optical network terminal line to the optical line terminal; an optical signal transmitter configured to transmit an optical signal to the optical signal transfer interface; an optical signal receiver configured to receive the downlink signal through the optical signal transfer interface, to receive a reflected signal corresponding to the optical signal, and to detect intensity of the downlink signal and the reflected signal; a signal converter configured to convert the reflected signal from an analog form to a digital form; a signal processor configured to analyze the reflected signal of a digital form and to determine the state of the optical network terminal line based on the analysis result; and a signal output interface configured to output the state of the optical network terminal line, it is possible to quickly and simply obtain state information of connection information of the optical network terminal line, and minimize time required for disconnection of the optical network terminal line from a port of splitter, and needs only equipment of a simple structure compared with existing measurement equipment for monitoring the state of the connection state between the optical network terminal and a drop fiber section, so that the cost of disconnection of the optical network terminal line is minimized.

### CROSS-REFERENCE TO RELATED APPLICATION

This application claims priority to and the benefit of Korean Patent Application No. 10-2018-0028887 filed in the Korean Intellectual Property Office on Mar. 12, 2018, the entire contents of which are incorporated herein by reference.

### BACKGROUND OF THE INVENTION

### (a) Field of the Invention

The present invention relates to a method and device for determining the state of a line of an optical network terminal side, and more particularly to a method and device for determining a state of an optical network terminal line connecting an optical network terminal to an optical line terminal.

### (b) Description of the Related Art

When a request for opening a service for connecting a new subscriber of an optical network to a passive optical network has occurred or a fault report for an already opened service occurs, an optical communication service company dispatches an operator, and the operator checks the state of a splitter of the optical network terminal side. The splitter of the optical network terminal side is equipped with a line of the optical line terminal (or optical base station terminal) connected from the optical line terminal (OLT), and a plurality of optical network terminal (ONT) lines connecting the line of the optical line terminal to the optical network terminal (drop fiber) are connected therewith.

When an optical network terminal line is newly opened to connect a new optical network terminal to the optical line terminal, it is necessary to determine whether a state of an existing port and an existing optical network terminal line connecting the optical network terminal to the splitter of the optical network terminal side is normal.

However, when the subscriber changes the service company or the subscriber moves his/her home, there are many cases that while the optical network terminal line of the optical network terminal in the subscriber's home is disconnected and unused, the optical network terminal line is connected to the port of the splitter of the optical network terminal side. Therefore, it is difficult for the operator to visually check the state of the optical network terminal line at the corresponding port (or branch point) by observing the splitter of the optical network terminal side, and thus it is difficult to carry out maintenance work.

In the case of the conventional art, an optical power meter and an optical time domain reflectometer (OTDR) have been used as measurement equipment to check the state of the optical network terminal line.

The optical power meter is a device for numerically measuring the loss of an optical network terminal line in an entire section to check the state of the optical network terminal line, and can only measure the intensity of the optical signal received at the measuring point. In the case of the optical power meter, when an optical signal from the optical network terminal is detected on an optical network terminal line, the port connected to the optical network terminal line can be determined as being in use. However, when the optical signal is not detected from the optical network terminal line, it is impossible to know exactly whether the optical network terminal is powered off, the port is disconnected, or the service is not provided to the optical network terminal.

The OTDR is measurement equipment that applies an optical pulse into the optical network terminal line to detect backscattering due to Rayleigh scattering in the optical network terminal line and reflected light generated in the junction point and the wave drawback, so as to search for trouble points and calculate transmission loss. When using OTDR equipment, it is possible to accurately determine the connection state of the optical network terminal lines, but it is inefficient to supply expensive measurement equipment such as an OTDR to all work sites requiring only simple state information of the optical network terminal line such a connection state of the optical network terminal line.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a method and device for determining a state of an optical network terminal line efficiently and easily, when field work for service opening of a new subscriber of the passive optical network is performed.

A device for determining a state of an optical network terminal line includes: an optical signal transfer interface configured to transfer a downlink signal transmitted from an optical line terminal to an optical network terminal line, and to transfer an uplink signal transmitted from an optical network terminal connected to the optical network terminal line to the optical line terminal; an optical signal transmitter configured to transmit an optical signal to the optical signal transfer interface; an optical signal receiver configured to receive the downlink signal through the optical signal transfer interface, to receive a reflected signal corresponding to the optical signal, and to detect intensity of the downlink signal and the reflected signal; a signal converter configured to convert the reflected signal from an analog form to a digital form; a signal processor configured to analyze the reflected signal of a digital form and to determine the state of the optical network terminal line based on the analysis result; and a signal output interface configured to output the state of the optical network terminal line.

The optical signal transmitter transmits a first optical signal of a first wavelength and a second optical signal of a second wavelength to the optical network terminal line.

The optical signal transmitter alternately transmits the first optical signal and the second optical signal at different times.

The signal processor analyzes a difference between a first reflected signal corresponding to the first optical signal and a second reflected signal corresponding to the second optical signal.

The signal processor determines the state of the optical network terminal line to be normal when intensity of the first reflected signal and the second reflected signal satisfy a first condition, determines the state of the optical network terminal line to be cut when the intensity of the first reflected signal and the second reflected signal satisfy a second condition, and determines the state of the optical network terminal line to be unplugged when the intensity of the first reflected signal and the second reflected signal satisfy a third condition.

The first condition includes a condition that the intensity of the first reflected signal is less than or equal to −20 dB, and the intensity of the second reflected signal is equal to or greater than 90% of the intensity of the first reflected signal.

The second condition includes a condition that the intensity of the first reflected signal and the intensity of the second reflected signal are between −20 dB and 20 dB.

The third condition includes a condition that the intensity of the first reflected signal and the intensity of the second reflected signal are less than or equal to −20 dB.

The signal processor determines the state of the optical network terminal line to be normal when intensity of the uplink signal is more than or equal to a threshold value.

The device further includes an anti-reflective lens between the optical network terminal and the optical network terminal line.

A method for determining a state of an optical network terminal line includes: transferring a downlink signal transmitted from an optical line terminal to an optical network terminal line; transferring an uplink signal transmitted from an optical network terminal connected to the optical network terminal line to the optical line terminal; transmitting an optical signal to the optical signal transfer interface; receiving the downlink signal through the optical signal transfer interface; receiving a reflected signal corresponding to the optical signal; detecting intensity of the downlink signal and the reflected signal; converting the reflected signal from an analog form to a digital form; analyzing the reflected signal of a digital form; determining the state of the optical network terminal line based on the analysis result; and outputting the state of the optical network terminal line.

The transmitting an optical signal includes transmitting a first optical signal of a first wavelength and a second optical signal of a second wavelength to the optical network terminal line.

The transmitting the first optical signal and the second optical signal includes alternately transmitting the first optical signal and the second optical signal at different times.

The analyzing the reflected signal includes analyzing a difference between a first reflected signal corresponding to the first optical signal and a second reflected signal corresponding to the second optical signal.

The determining the state of the optical network terminal line includes: determining the state of the optical network terminal line to be normal when intensity of the first reflected signal and the second reflected signal satisfy a first condition; determining the state of the optical network terminal line to be cut when the intensity of the first reflected signal and the second reflected signal satisfy a second condition, and determining the state of the optical network terminal line to be unplugged when the intensity of the first reflected signal and the second reflected signal satisfy a third condition.

The first condition includes a condition that the intensity of the first reflected signal is less than or equal to −20 dB, and the intensity of the second reflected signal is equal to or greater than 90% of the intensity of the first reflected signal.

The second condition includes a condition that the intensity of the first reflected signal and the intensity of the second reflected signal are between −20 dB and 20 dB.

The third condition includes a condition that the intensity of the first reflected signal and the intensity of the second reflected signal are less than or equal to −20 dB.

The determining the state of the optical network terminal line includes determining the state of the optical network terminal line to be normal when intensity of the uplink signal is more than or equal to a threshold value.

A device for determining a state of an optical network terminal line includes: an optical signal transfer interface configured to transfer a downlink signal transmitted from an optical line terminal to an optical network terminal line, and to transfer an uplink signal transmitted from an optical network terminal connected to the optical network terminal line to the optical line terminal; an optical signal transmitter configured to transmit a first optical signal of a first wavelength and a second optical signal of a second wavelength to the optical signal transfer interface; an optical signal receiver configured to receive the downlink signal through the optical signal transfer interface, to receive a first reflected signal corresponding to the first optical signal and a second reflected signal corresponding to the second optical signal, and to detect intensity of the downlink signal, the first reflected signal, and the second reflected signal; a signal converter configured to convert the first reflected signal and the second reflected signal from an analog form to a digital form; a signal processor configured to analyze the first reflected signal and the second reflected signal of a digital form, and to determine the state of the optical network terminal line based on the analysis result; and a signal output interface configured to output the state of the optical network terminal line.

According to an exemplary embodiment of the present invention, in the case of the passive optical network, it is possible to obtain connection state information of the optical network terminal line, so time required for releasing the optical network terminal line from the port of the splitter is minimized.

Also, in the case of the passive optical network, since only equipment with a simple structure is required compared to the conventional measurement equipment used for monitoring the connection state between the optical network terminal and the drop fiber section, cost required for releasing the optical network terminal line is minimized.

### BRIEF DESCRIPTION OF THE DRAWINGS

FIG. 1 shows a passive optical network according to an exemplary embodiment of the present invention.

FIGS. 2A, 2B, and 2C shows examples of a passive optical network according to an exemplary embodiment of the present invention.

FIG. 3 shows a block diagram of a passive optical network according to an exemplary embodiment of the present invention.

FIG. 4 shows a block diagram of a passive optical network according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may indicate a mobile terminal, a mobile station, an advanced mobile station, a high reliability mobile station, a subscriber station, a portable subscriber station, an access terminal, or user equipment, and it may include entire or partial functions of the terminal, the mobile terminal, the mobile station, the advanced mobile station, the high reliability mobile station, the subscriber station, the portable subscriber station, the access terminal, or the user equipment.

In addition, a base station (BS) may indicate an advanced base station, a high reliability base station, a node B, an evolved node B (eNodeB), an access point, a radio access station, a base transceiver station, a mobile multihop relay (MMR)-BS, a relay station functioning as a base station, a high reliability relay station functioning as a base station, a repeater, a macro base station, or a small base station, and it may include entire or partial functions of the base station, the advanced base station, the HR-BS, the nodeB, the eNodeB, the access point, the radio access station, the base transceiver station, the MMR-BS, the relay station, the high reliability relay station, the repeater, the macro base station, or the small base station.

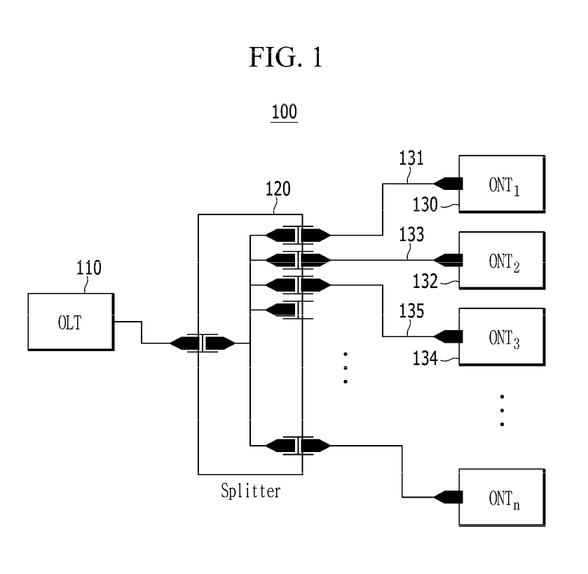

FIG. 1 shows a passive optical network according to an exemplary embodiment of the present invention.

As shown in FIG. 1, the passive optical network 100 includes an optical line terminal (OLT) 110, a plurality of optical network terminals (ONT₁, ONT₂, ONT₃) 130, 132, and 134, a splitter 120 for connecting the optical line terminal 110 with the plurality of optical network terminals 130, 132, and 134, and a plurality of optical network terminal lines 131, 133, and 135 for connecting the plurality of optical network terminals 130, 132, and 134 to the splitter 120.

In an example, the first optical network terminal line 131 is in uninterrupted state throughout the entire section, a first optical network terminal 130 (ONT₁) among the plurality of optical network terminals 130, 132, 134 is connected to the first optical network terminal line 131, and the first optical network terminal line 131 connects the first optical network terminal 130 (ONT₁) with the splitter 120.

In another example, a second optical network terminal line 133 is cut in a partial section, and fails to connect the second optical network terminal 132 (ONT₂) with the splitter 120.

In a further example, a third optical network terminal line 135 is not disconnected in the entire section, but a third optical network terminal (ONT₃) 134 among the plurality of optical network terminals 130, 132, and 134 is not connected with the third optical network terminal line 135.

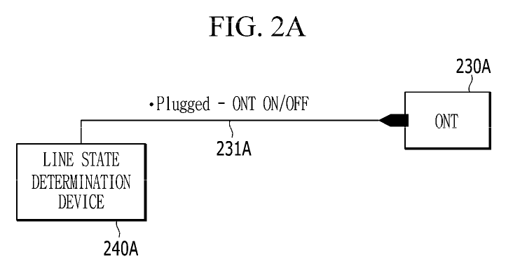

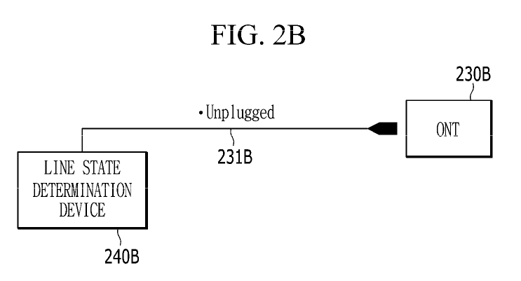

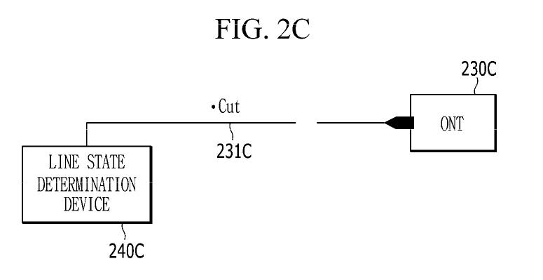

An optical network terminal line state determination device described below referring to FIG. 2 to FIG. 4 may determine the connection state of the optical network terminal line of the three illustrated cases described above.

FIGS. 2A, 2B, and 2C shows examples of a passive optical network according to an exemplary embodiment of the present invention.

The optical network terminal line state determination devices 240A, 240B, and 240C may determine each state of the optical network terminal line (drop fiber) shown in FIGS. 2A, 2B, and 2C differently, and the operator must know the connection state of the optical network terminal line to perform field operations associated with the optical network terminal lines (e.g., operation of releasing the optical network terminal line).

As shown in FIG. 2A, an optical network terminal line state determination device 240A identifies the state in which an optical network terminal line 231A is not disconnected in the entire section and the optical network terminal line 231A is connected with an optical network terminal (ONT) 230A, and determines the state of the optical network terminal lines 231A as shown in FIG. 2A as “Plugged”.

As shown in FIG. 2B, an optical network terminal line state determination device 240B identifies the state in which an optical network terminal line 231B is not disconnected in the entire section but the optical network terminal line 231B is disconnected from an optical network terminal (ONT) 230B, and determines the state of the optical network terminal line 231B as shown in FIG. 2B as “Unplugged”.

As shown in FIG. 2C, an optical network terminal line state determination device 240C identifies the state in which an optical network terminal line 231C is disconnected in a partial section among the entire section, and determines the state of the optical network terminal line 231C as shown in FIG. 2C as “Cut”.

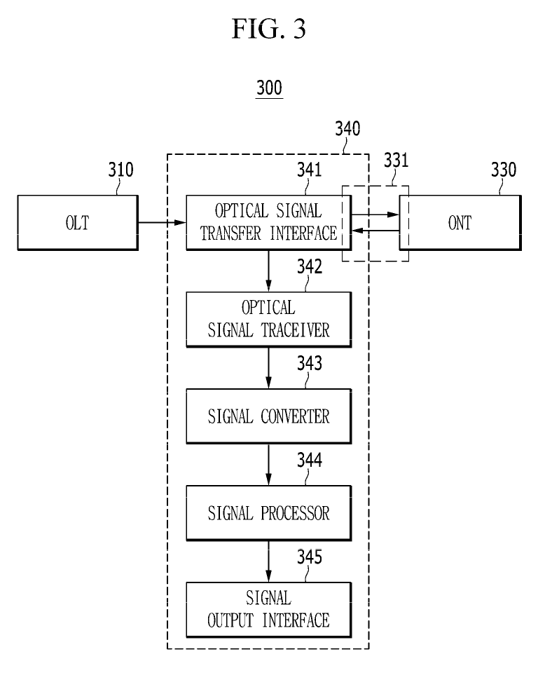

FIG. 3 shows a block diagram of a passive optical network according to an exemplary embodiment of the present invention.

As shown in FIG. 3, the passive optical network 300 may include an OLT 310, an ONT 330, and an optical network terminal line state determination device 340.

The OLT 310 may transmit a downlink signal to the ONT 330 through an optical network terminal line 331.

The ONT 330 may transmit an uplink signal corresponding to the downlink signal to the OLT 310 through the optical network terminal line 331.

The optical network terminal line state determination device 340 may determine a state of the optical network terminal line 331 described above.

The optical network terminal line state determination device 340 may include an optical signal transfer interface 341, an optical signal transceiver 342, a signal converter 343, a signal processor 344, and a signal output interface 345.

The optical signal transfer interface 341 may include a plurality of couplers. For example, each of the couplers may be a 1:2 coupler that splits a received signal into two signals and transfers them by different paths. The optical signal transfer interface 341 may transfer a downlink signal received from the OLT 310 to the ONT 330. The optical signal transfer interface 341 may transfer an uplink signal received from the ONT 330 to the OLT 330 and the optical signal transceiver 342.

The optical signal transceiver 342 may include an optical signal transmitter (LD) for outputting an optical signal of a specific wavelength. The optical signal transmitter may transmit the optical signal of the specific wavelength to the ONT 330 through the optical signal transfer interface 341. The optical signal transmitter may include a first optical output interface LD1 generating a first optical signal of a first wavelength and a second optical output interface LD2 generating a second optical signal of a second wavelength.

The optical signal transceiver 342 includes an optical signal receiver for measuring intensity of the downlink signal output from the ONT 330, measuring intensity of the first reflected optical signal and the second reflected optical signal reflected from the ONT 330 corresponding to the first optical signal and the second optical signal, and converting the first reflected optical signal and the second reflected optical signal to a first reflected electrical signal and a second reflected electrical signal. The optical signal receiver may include a photodiode (PD).

The signal converter 343 may include an analogue digital converter (ADC) for converting the first reflected electrical signal and the second reflected electrical signal of an analog form to a first reflected electrical signal and a second reflected electrical signal of a digital form.

The signal processor 344 collects the first and second reflected electrical signals of a digital form converted by the ADC, and determines the connection state of the optical network terminal line based on the collected information.

The signal converter 343 and the signal processor 344 may be provided in a single chip in one processor.

The signal output interface 345 may include a display for outputting the connection state of the optical network terminal line. The display may consist of an LCD or LED.

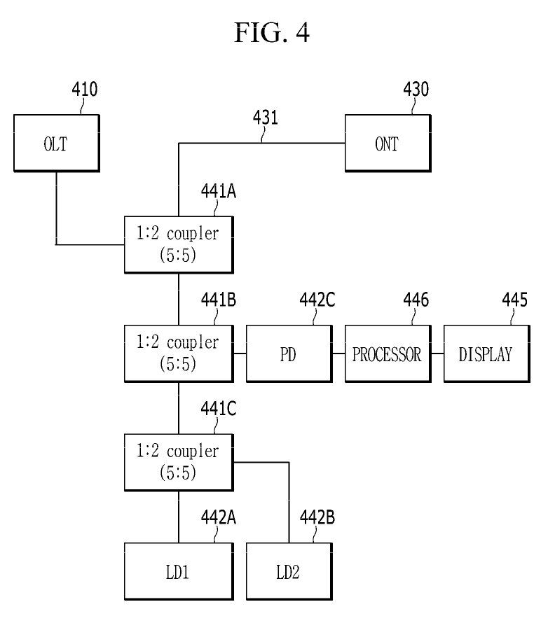

FIG. 4 shows a block diagram of passive optical network according to an exemplary embodiment of the present invention.

As shown in FIG. 4, the OLT 310 shown in FIG. 3 may correspond to an OLT 410 shown in FIG. 4, the ONT 330 may correspond to an ONT 430 shown in FIG. 4, the optical signal transfer interface 340 shown in FIG. 3 may correspond to a plurality of couplers 441A, 441B, and 441C (1:2 couplers) shown in FIG. 4, the optical signal transceiver 342 shown in FIG. 3 may correspond to a first optical output interface 442A (LD1), a second optical output interface 442B (LD2), and a photodiode 442C (PD) shown in FIG. 4, the signal converter 343 and the signal processor 344 shown in FIG. 3 may correspond to a processor 446 shown in FIG. 4, and the signal output interface 345 shown in FIG. 3 may correspond to a display 445 shown in FIG. 4.

First, when a user input is received while the OLT 410 and the ONT 430 are connected through the first coupler 441A and an optical network terminal line 431, the OLT 410 transmits a downlink signal to the ONT 430.

When the ONT 430 and the optical network terminal line 431 are normally connected to the OLT 410, the photodiode 442C detects an uplink signal of higher than a threshold value corresponding to the downlink signal from the ONT 430 through the optical network terminal line 431, the first coupler 441A, and the second coupler 441B. When the ONT 430 and the optical network terminal line 431 are unplugged or the connection of a partial section of the optical network terminal line 431 is cut, the photodiode 442C detects an uplink signal of lower than another threshold value.

If the photodiode 442C detects an uplink signal of lower than the other threshold value from the ONT 430, the photodiode 442C releases the connection between the OLT 410 and the first coupler 441A according to the user input.

Then, based on the user input, the first optical output interface 442A outputs the first optical signal of the first wavelength to the optical network terminal line 431 through the third coupler 441C, the second coupler 441B, and the first coupler 441A, and outputs the second optical signal of the second wavelength to the optical network terminal line 431 through the third coupler 441C, the second coupler 441B, and the first coupler 441A.

Then, the photodiode 442C may receive the first and second optical signals, which are the reflected signals that are reflected back through the optical network terminal line 431. The photodiode 442C may convert the first and second reflected electrical signals to first and second reflected optical signal electrical signals.

The ADC included in the processor 446 may convert the first and second reflected electrical signals of an analog form into first and second reflected optical signals of a digital form.

A micro control unit (MCU) included in the processor 446 compares and/or analyzes intensity of the first and second reflected optical signals of a digital form, and determines the connection state of the optical network terminal line 431 based on the analysis results.

TABLE 1

| | Intensity of LD1 optical | Intensity of LD2 optical signal |
|---|---|---|
| | signal reflection signal | reflection signal |
| Plugged | ≤−20 dB | ≥≥ LD1 × 0.9 dB |
| Unplugged | −20 dB ≤ × ≤ 0 dB | −20 dB ≤ × ≤ −0 dB |
| Cut | ≤−20 dB | ≤≤−20 dB |

The processor 446 determines whether the intensity of the first and second reflected electrical signals is less than or equal to −20 dB, greater than −20 dB while less than 20 dB, or the intensity of the second reflected electrical signal is greater than 90% of the intensity of the first reflected electrical signal, and determines the connection state of the optical network terminal line 431 as one of “Plugged”, “Unplugged”, or “Cut”. The values illustrated in Table 1 may vary depending on intensity of the output signal of the first and second optical output interfaces 442A and 442B. In addition, the values illustrated in Table 1 may vary depending on detection performance of the photodiode 442C.

If the first and second optical signals pass through the optical network terminal line 431 and are in contact with air, the intensity of the reflected signals may be constant, but if the first and second optical signals pass through the optical network terminal line 431 and are in contact with the ONT 430, the intensity of the reflected signals may vary depending on the type of the ONT 430. This is because reflection loss of the photodiode used in the ONT 430 is slightly different depending on a product. Therefore, for a more accurate judgment, a certain value of a range should be configured as shown in Table 1.

On the other hand, an anti-reflection lens (or anti-reflection coating) may be configured on a surface of the ONT 430. Since the non-reflective lens filters a specific component of a specific wavelength among the entire components of the optical signal, only the downlink signal output from the OLT 410 can be received.

Meanwhile, the processor 446 may display the determination result on the optical network terminal line on the display 445.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A device for determining a state of an optical network terminal line, comprising:
an optical signal transfer interface configured to transfer a downlink signal transmitted from an optical line terminal to an optical network terminal line, and to transfer an uplink signal transmitted from an optical network terminal connected to the optical network terminal line to the optical line terminal;
an optical signal transmitter configured to transmit an optical signal to the optical signal transfer interface;
an optical signal receiver configured to receive the downlink signal through the optical signal transfer interface, to receive a reflected signal corresponding to the optical signal, and to detect intensity of the downlink signal and the reflected signal;
a signal converter configured to convert the reflected signal from an analog form to a digital form;
a signal processor configured to analyze the reflected signal of a digital form and to determine the state of the optical network terminal line based on the analysis result; and
a signal output interface configured to output the state of the optical network terminal line.

2. The device of claim 1, wherein the optical signal transmitter transmits a first optical signal of first wavelength and a second optical signal of second wavelength to the optical network terminal line.

3. The device of claim 2, wherein the optical signal transmitter alternately transmits the first optical signal and the second optical signal at different times.

4. The device of claim 3, wherein the signal processor analyzes a difference between a first reflected signal corresponding to the first optical signal and a second reflected signal corresponding to the second optical signal.

5. The device of claim 4, wherein the signal processor:
determines the state of the optical network terminal line to be normal when intensity of the first reflected signal and the second reflected signal satisfy a first condition,
determines the state of the optical network terminal line to be cut when the intensity of the first reflected signal and the second reflected signal satisfy a second condition, and
determines the state of the optical network terminal line to be unplugged when the intensity of the first reflected signal and the second reflected signal satisfy a third condition.

6. The device of claim 5, wherein the first condition includes a condition that the intensity of the first reflected signal is less than or equal to −20 dB and the intensity of the second reflected signal is equal to or greater than 90% of the intensity of the first reflected signal.

7. The device of claim 5, wherein the second condition includes a condition that the intensity of the first reflected signal and the intensity of the second reflected signal is between −20 dB and 20 dB.

8. The device of claim 5, wherein the third condition includes a condition that the intensity of the first reflected signal and the intensity of the second reflected signal are less than or equal to −20 dB.

9. The device of claim 1, wherein the signal processor determines the state of the optical network terminal line to be normal when intensity of the uplink signal is more than or equal to a threshold value.

10. The device of claim 1, further comprising:
an anti-reflective lens between the optical network terminal and the optical network terminal line.

11. A method for determining a state of an optical network terminal line, comprising:
transferring a downlink signal transmitted from an optical line terminal to an optical network terminal line;
transferring an uplink signal transmitted from an optical network terminal connected to the optical network terminal line to the optical line terminal;
transmitting an optical signal to the optical signal transfer interface;
receiving the downlink signal through the optical signal transfer interface;
receiving a reflected signal corresponding to the optical signal;
detecting intensity of the downlink signal and the reflected signal;
converting the reflected signal from an analog form to a digital form;
analyzing the reflected signal of a digital form;
determining the state of the optical network terminal line based on the analysis result; and
outputting the state of the optical network terminal line.

12. The method of claim 11, wherein transmitting an optical signal comprises transmitting a first optical signal of first wavelength and a second optical signal of second wavelength to the optical network terminal line.

13. The method of claim 12, wherein transmitting the first optical signal and the second optical signal comprises alternately transmitting the first optical signal and the second optical signal at different times.

14. The method of claim 13, wherein analyzing the reflected signal comprises analyzing a difference between a first reflected signal corresponding to the first optical signal and a second reflected signal corresponding to the second optical signal.

15. The method of claim 14, wherein determining the state of the optical network terminal line comprises:
determining the state of the optical network terminal line to be normal when intensity of the first reflected signal and the second reflected signal satisfy a first condition;
determining the state of the optical network terminal line to be cut when the intensity of the first reflected signal and the second reflected signal satisfy a second condition, and
determining the state of the optical network terminal line to be unplugged when the intensity of the first reflected signal and the second reflected signal satisfy a third condition.

16. The method of claim 15, wherein the first condition includes a condition that the intensity of the first reflected signal is less than or equal to −20 dB, and the intensity of the second reflected signal is equal to or greater than 90% of the intensity of the first reflected signal.

17. The method of claim 15, wherein the second condition includes a condition that the intensity of the first reflected signal and the intensity of the second reflected signal is between −20 dB and 20 dB.

18. The method of claim 15, wherein the third condition includes a condition that the intensity of the first reflected signal and the intensity of the second reflected signal are less than or equal to −20 dB.

19. The method of claim 11, wherein determining the state of the optical network terminal line comprises determining the state of the optical network terminal line to be normal when intensity of the uplink signal is more than or equal to a threshold value.

20. A device for determining a state of an optical network terminal line, comprising:
an optical signal transfer interface configured to transfer a downlink signal transmitted from an optical line terminal to an optical network terminal line, and to transfer an uplink signal transmitted from an optical network terminal connected to the optical network terminal line to the optical line terminal;
an optical signal transmitter configured to transmit a first optical signal of a first wavelength and a second optical signal of a second wavelength to the optical signal transfer interface;
an optical signal receiver configured to receive the downlink signal through the optical signal transfer interface, to receive a first reflected signal corresponding to the first optical signal and a second reflected signal corresponding to the second optical signal, and to detect intensity of the downlink signal, the first reflected signal, and the second reflected signal;
a signal converter configured to convert the first reflected signal and the second reflected signal from an analog form to a digital form;
a signal processor configured to analyze the first reflected signal and the second reflected signal of a digital form, and to determine the state of the optical network terminal line based on the analysis result; and
a signal output interface configured to output the state of the optical network terminal line.
